(19) United States
(12) Patent Application Publication
(10) Pub. No.: US 2026/0203594 A1
(43) Pub. Date: Jul. 16, 2026

(54) IDENTIFYING IMPACT OF INPUTS ON ARTIFICIAL INTELLIGENCE BASED MODELS

(71) Applicant: International Business Machines Corporation, Armonk, NY (US)

(72) Inventors: Michael James McGuire, North Kellyville (AU); Langley Millard, Sydney (AU); James David Cleaver, Grose Wold (AU); Tamera Aboualy, Etobicoke (CA)

(21) Appl. No.: 19/020,762

(22) Filed: Jan. 14, 2025

(51) Int. Cl. G06N 3/094

(52) U.S. Cl. CPC G06N 3/094

(57) ABSTRACT

A method, according to one approach, includes: determining influence strengths of features corresponding to an AI based model. High risk datapoints are identified based at least in part on the influence strengths of the features, and real-time inputs for the high risk datapoints of the respective features are evaluated. The method also includes identifying potentially malicious input(s) based at least in part on the evaluation of the real-time inputs and/or the determined influence strengths. Moreover, the method includes dynamically determining how to mitigate an impact the potentially malicious input(s) have on the AI based model.

### BACKGROUND

The present invention relates to artificial intelligence (AI) based models, and more specifically, this invention relates to evaluating inputs of AI based models.

AI based models have emerged in recent years, providing users the ability to submit various requests (e.g., prompts) that are evaluated and answered in real-time. For example, machine learning models often rely on external, uncontrolled data sources (e.g. edge sensors managed by an external party) to predict outcomes. Thus, in situations where an AI based model is overly reliant on a particular input (e.g., sensor), it leaves the model vulnerable to a form of poisoned injection attack where a malicious actor forces the sensor in question to act abnormally.

The complexity and difficulty in explaining AI based models like neural networks and some machine learning models, combined with the fact that the models are typically optimized to rely on a minimum number of inputs to produce the desired outcomes, means that they are susceptible to poisoned injection style attacks. In other words, a malicious actor may supply modified or false data to deliberately manipulate how the AI based model responds. Conventional products have been unable to overcome this vulnerability, and are susceptible to targeted malicious input.

### SUMMARY

A method, according to one approach, includes: determining influence strengths of features corresponding to an AI based model. High risk datapoints are identified based at least in part on the influence strengths of the features, and real-time inputs for the high risk datapoints of the respective features are evaluated. The method also includes identifying potentially malicious input(s) based at least in part on the evaluation of the real-time inputs and/or the determined influence strengths. Moreover, the method includes dynamically determining how to mitigate an impact the potentially malicious input(s) have on the AI based model.

A computer program product, according to another approach, includes: one or more computer-readable storage media. The computer program product also includes program instructions that are stored on the one or more storage media to perform the foregoing method.

A computer system, according to yet another approach, includes: a processor set, and one or more computer-readable storage media. The computer system also includes program instructions that are stored on the one or more storage media to cause the processor set to perform the foregoing method.

Other aspects and implementations of the present invention will become apparent from the following detailed description, which, when taken in conjunction with the drawings, illustrate by way of example the principles of the invention.

### BRIEF DESCRIPTION OF THE DRAWINGS

FIG. 1 is a diagram of a computing environment, in accordance with one approach.

FIG. 2 is a representational view of a distributed system, in accordance with one approach.

FIG. 3A is a flowchart of a method, in accordance with one approach.

FIG. 3B is a flowchart of sub-operations for one of the operations in the method of FIG. 3A, in accordance with one approach.

FIG. 3C is a flowchart of sub-operations for one of the operations in the method of FIG. 3A, in accordance with one approach.

### DETAILED DESCRIPTION

The following description is made for the purpose of illustrating the general principles of the present invention and is not meant to limit the inventive concepts claimed herein. Further, particular features described herein can be used in combination with other described features in each of the various possible combinations and permutations.

Unless otherwise specifically defined herein, all terms are to be given their broadest possible interpretation including meanings implied from the specification as well as meanings understood by those skilled in the art and/or as defined in dictionaries, treatises, etc.

It must also be noted that, as used in the specification and the appended claims, the singular forms “a,” “an” and “the” include plural referents unless otherwise specified. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The following description discloses several preferred approaches of systems, methods and computer program products for monitoring inputs provided to AI based models. Approaches herein evaluate and address the risk associated with building models that rely on an undesirably low number of inputs to generate a result. These approaches not only identify these risks by evaluating the inner workings of an AI based model(s), but also determine how to modify the AI based model(s) to mitigate those risks, and further still how to put metrics in place to detect those risks being exploited moving forward. Approaches herein may thereby identify attack vectors intrinsic to AI models using different processes, monitor inputs intended for the AI models in real-time, and dynamically determine how to mitigate the impact potentially malicious input(s) have on the AI based models, e.g., as will be described in further detail below.

In one general approach, a method includes: determining influence strengths of features corresponding to an AI based model. High risk datapoints are identified based at least in part on the influence strengths of the features, and real-time inputs for the high risk datapoints of the respective features are evaluated. The method also includes identifying potentially malicious input(s) based at least in part on the evaluation of the real-time inputs and/or the determined influence strengths. Moreover, the method includes dynamically determining how to mitigate an impact the potentially malicious input(s) have on the AI based model.

In another general approach, a computer program product includes: one or more computer-readable storage media. The computer program product also includes program instructions that are stored on the one or more storage media to perform the foregoing method.

In yet another general approach, a computer system includes: a processor set, and one or more computer-readable storage media. The computer system also includes program instructions that are stored on the one or more storage media to cause the processor set to perform the foregoing method.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 100 contains an example of an environment for the execution of at least some of the computer code involved in performing the inventive methods, such as improved input verification code at block 150 for monitoring the datapoints provided as inputs to one or more AI based models. Approaches herein evaluate and address the risk associated with building models that rely on an undesirably low number of inputs to produce a result. These approaches not only identify these risks by evaluating the inner workings of an AI based model(s), but also determine how to modify the AI based model(s) to mitigate those risks, and further still how to put metrics in place to detect those risks being exploited moving forward. Approaches herein may thereby identify attack vectors intrinsic to AI models using different processes, monitor inputs intended for the AI models in real-time, and dynamically determine how to mitigate the impact potentially malicious input(s) have on the AI based models, e.g., as will be described in further detail below.

In addition to block 150, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 150, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

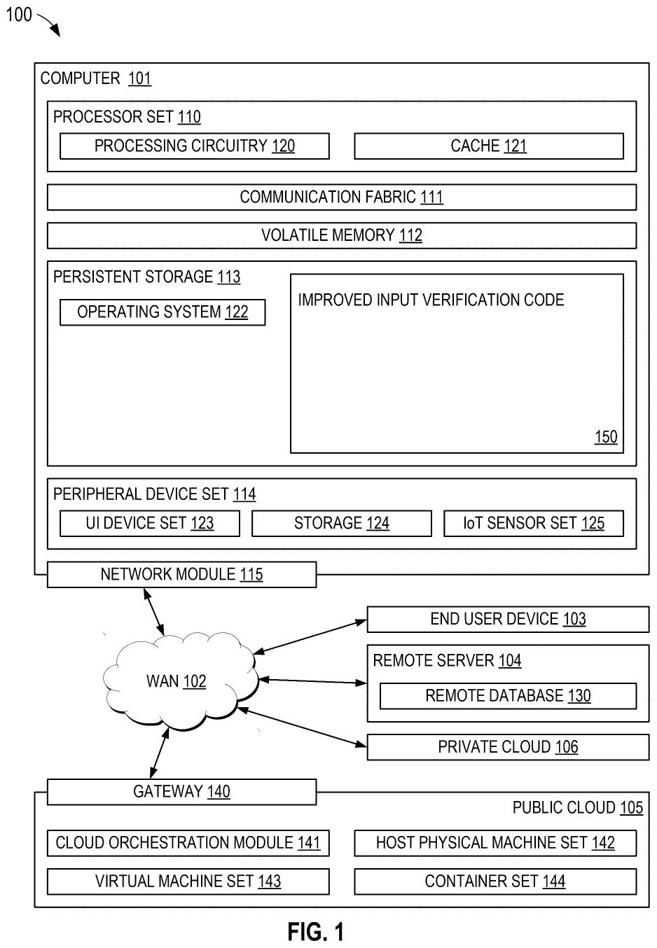

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 150 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up buses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 150 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer, and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

CLOUD COMPUTING SERVICES AND/OR MICROSERVICES (not separately shown in FIG. 1): private and public clouds 106 are programmed and configured to deliver cloud computing services and/or microservices (unless otherwise indicated, the word “microservices” shall be interpreted as inclusive of larger “services” regardless of size). Cloud services are infrastructure, platforms, or software that are typically hosted by third-party providers and made available to users through the internet. Cloud services facilitate the flow of user data from front-end clients (for example, user-side servers, tablets, desktops, laptops), through the internet, to the provider's systems, and back. In some embodiments, cloud services may be configured and orchestrated according to as “as a service” technology paradigm where something is being presented to an internal or external customer in the form of a cloud computing service. As-a-Service offerings typically provide endpoints with which various customers interface. These endpoints are typically based on a set of APIs. One category of as-a-service offering is Platform as a Service (PaaS), where a service provider provisions, instantiates, runs, and manages a modular bundle of code that customers can use to instantiate a computing platform and one or more applications, without the complexity of building and maintaining the infrastructure typically associated with these things. Another category is Software as a Service (SaaS) where software is centrally hosted and allocated on a subscription basis. SaaS is also known as on-demand software, web-based software, or web-hosted software. Four technological sub-fields involved in cloud services are: deployment, integration, on demand, and virtual private networks.

In some aspects, a system according to various embodiments may include a processor and logic integrated with and/or executable by the processor, the logic being configured to perform one or more of the process steps recited herein. The processor may be of any configuration as described herein, such as a discrete processor or a processing circuit that includes many components such as processing hardware, memory, I/O interfaces, etc. By integrated with, what is meant is that the processor has logic embedded therewith as hardware logic, such as an application specific integrated circuit (ASIC), a FPGA, etc. By executable by the processor, what is meant is that the logic is hardware logic; software logic such as firmware, part of an operating system, part of an application program; etc., or some combination of hardware and software logic that is accessible by the processor and configured to cause the processor to perform some functionality upon execution by the processor. Software logic may be stored on local and/or remote memory of any memory type, as known in the art. Any processor known in the art may be used, such as a software processor module and/or a hardware processor such as an ASIC, a FPGA, a central processing unit (CPU), an integrated circuit (IC), a graphics processing unit (GPU), etc.

Of course, this logic may be implemented as a method on any device and/or system or as a computer program product, according to various approaches.

As noted above, AI based models have emerged in recent years, providing users the ability to submit various requests (e.g., prompts) that are evaluated and answered in real-time. For example, machine learning models often rely on external, uncontrolled data sources (e.g. edge sensors managed by an external party) to predict outcomes. Thus, in situations where an AI based model is overly reliant on a particular input (e.g., sensor), it leaves the model vulnerable to a form of poisoned injection attack where a malicious actor forces the sensor in question to act abnormally.

The complexity and difficulty in explaining AI based models like neural networks and some machine learning models, combined with the fact that the models are typically optimized to rely on a minimum number of inputs to produce the desired outcomes, means that they are susceptible to poisoned injection style attacks. In other words, a malicious actor may supply modified or false data to deliberately manipulate how the AI based model responds. Conventional products have been unable to overcome this vulnerability, and are susceptible to targeted malicious input.

In sharp contrast to the foregoing conventional shortcomings, approaches herein are desirably able to evaluate AI based models (also referred to herein as “models” and “AI models”) and identify feature dependence therein. This feature dependence desirably provides insight as to how vulnerable an AI model is to an attacker maliciously manipulating input data for the model, e.g., such as edge sensor data. Approaches also evaluate feature interdependence, providing insight as to whether existing features can be used to ameliorate poisoned injection attacks. Mitigation recommendations may further be provided by identifying additional inputs (e.g., data sources) that may be used to ameliorate an attack vector. Some approaches are able to generate additional steps configured to further secure the inputs (e.g., data sources) to an AI model and ensure accurate representation of the system being evaluated.

For instance, some approaches implement models that use principal component analysis (PCA) or other methods that implement co-linearity between some of the dimensions of variables. Approaches herein further utilize the relationships between these co-linear components as an additional feature to detect when a given model shifts out of range. In other words, approaches utilize the co-linearity between variables as well as the relationships between the variables themselves to identify whether one or more of the input sources have been compromised. Furthermore, some approaches are able to generate synthetic and/or digital twin style data to robustly design and test models to have more of an intrinsic resilience to similar types of attacks, e.g., as will be described in further detail below.

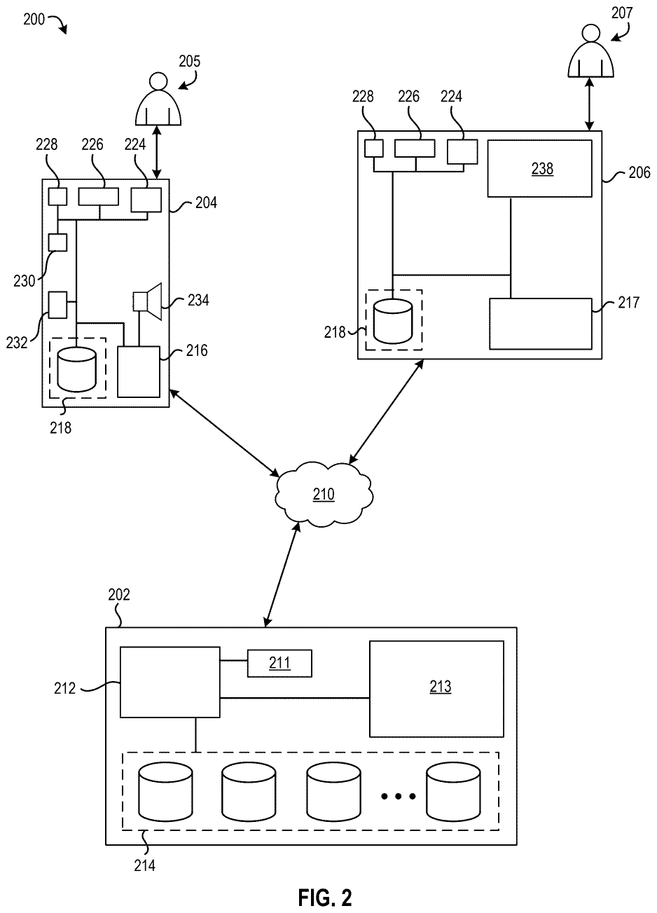

Looking now to FIG. 2, a system 200 having a distributed architecture is illustrated in accordance with one approach. As an option, the present system 200 may be implemented in conjunction with features from any other approach listed herein, such as those described with reference to the other FIGS., such as FIG. 1. However, such system 200 and others presented herein may be used in various applications and/or in permutations which may or may not be specifically described in the illustrative approaches or implementations listed herein. Further, the system 200 presented herein may be used in any desired environment. Thus FIG. 2 (and the other FIGS.) may be deemed to include any possible permutation.

As shown, the system 200 includes a central server 202 that is connected to a user device 204, and edge node 206 accessible to the user 205 and administrator 207, respectively. The user device 204 and edge node 206 may thereby be considered endpoint devices, each of which are connected to the central server 202. The central server 202, user device 204, and edge node 206 are each connected to a network 210, and may thereby be positioned in different geographical locations. The network 210 may be of any type, e.g., depending on the desired approach. For instance, in some approaches the network 210 is a WAN, e.g., such as the Internet. However, an illustrative list of other network types which network 210 may implement includes, but is not limited to, a LAN, a PSTN, a SAN, an internal telephone network, etc. As a result, any desired information, data, commands, instructions, responses, requests, etc. may be sent between user device 204, edge node 206, and/or central server 202, regardless of the amount of separation which exists therebetween, e.g., despite being positioned at different geographical locations. According to some approaches, the central server 202 is a remote cloud server that is connected to (e.g., may be accessed by) user device 204 and/or edge node 206.

However, it should be noted that two or more of the user device 204, edge node 206, and central server 202 may be connected differently depending on the approach. According to an example, which is in no way intended to limit the invention, two servers (e.g., nodes) may be located relatively close to each other and connected by a wired connection, e.g., a cable, a fiber-optic link, a wire, etc.; etc., or any other type of connection which would be apparent to one skilled in the art after reading the present description.

The terms “user” and “administrator” are in no way intended to be limiting either. For instance, while users and administrators may be described as being individuals in various implementations herein, a user and/or an administrator may be an application, an organization, a preset process, etc. The use of “data,” “metadata,” and “information” herein are in no way intended to be limiting either, and may include any desired type of details, e.g., depending on the type of operating system implemented on the user device 204, edge node 206, and/or central server 202. In some approaches, sensor readings that are taken by logical and/or physical components at the edge node 206 and/or user device 204 may be kept at the edge node 206 for evaluation using one or more AI based models, e.g., as will soon become apparent.

The central server 202 includes a large (e.g., robust) processor 212 coupled to a cache 211, an AI module 213, and a data storage array 214 having a relatively high storage capacity. The AI module 213 may include any desired number and/or type of AI-based models, e.g., such as machine learning models, deep learning models, neural networks, etc. In preferred approaches, the AI module 213 includes one or more models that have been trained to identify attack vectors intrinsic to AI models using different processes, monitor inputs intended for the AI models in real-time, and dynamically determine how to mitigate the impact potentially malicious input(s) have on the AI based models. For instance, some approaches include AI models that have been trained to determine the influence strengths different features in a given model have on the output(s) produced by the model. The AI module 213 may thereby include models that are able to evaluate other trained models, and determine the way the features weigh on the nodes in the other respective models. In other words, AI module 213 and/or processor 212 may be able to determine the way features in an AI model are impacting the weights applied in the AI model, e.g., as will be described in further detail below.

With continued reference to FIG. 2, user device 204 includes a processor 216 which is coupled to memory 218. The processor 216 receives inputs from and interfaces with user 205. For instance, the user 205 may input information and/or queries using one or more of: a display screen 224, keys of a computer keyboard 226, a computer mouse 228, a microphone 230, and a camera 232. The processor 216 may thereby be configured to receive inputs (e.g., text, sounds, images, motion data, etc.) from any of these components as entered by the user 205. These inputs typically correspond to information presented on the display screen 224 while the entries were received. Moreover, the inputs received from the keyboard 226 and computer mouse 228 may impact the information shown on display screen 224, data stored in memory 218, information collected from the microphone 230 and/or camera 232, status of an operating system being implemented by processor 216, etc. The electronic device 204 also includes a speaker 234 which may be used to play (e.g., project) audio signals for the user 205 to hear.

Looking now to the edge node 206, some of the components included therein may be the same or similar to those included in user device 204, some of which have been given corresponding numbering. For instance, controller 217 is coupled to memory 218, a display screen 224, keys of a computer keyboard 226, and a computer mouse 228. Additionally, the controller 217 is coupled to an AI module 238. As described above with respect to AI module 213, the AI module 238 may include one or more historical question-answer modelers that are able to identify attack vectors intrinsic to AI models using different processes, monitor inputs intended for the AI models in real-time, and dynamically determine how to mitigate the impact potentially malicious input(s) have on the AI based models. For instance, some approaches include AI models that have been trained to determine the influence strengths different features in a given model have on the output(s) produced by the model. The AI module 213 may thereby include models that are able to evaluate other trained models, and determine the way the features weigh on the nodes in the other respective models. In other words, AI module 213 and/or processor 212 may be able to determine the way features in an AI model are impacting the weights applied in the AI model, e.g., as will be described in further detail below.

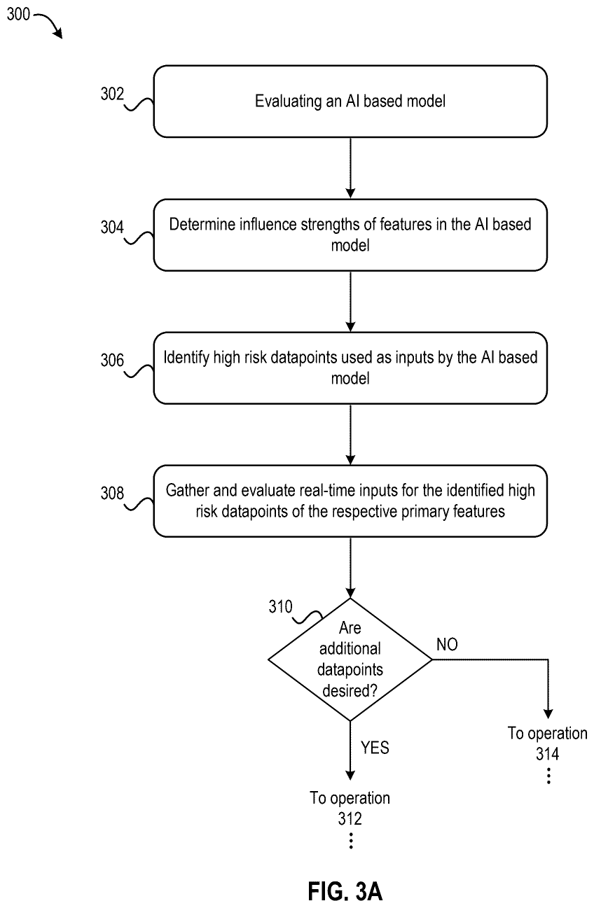

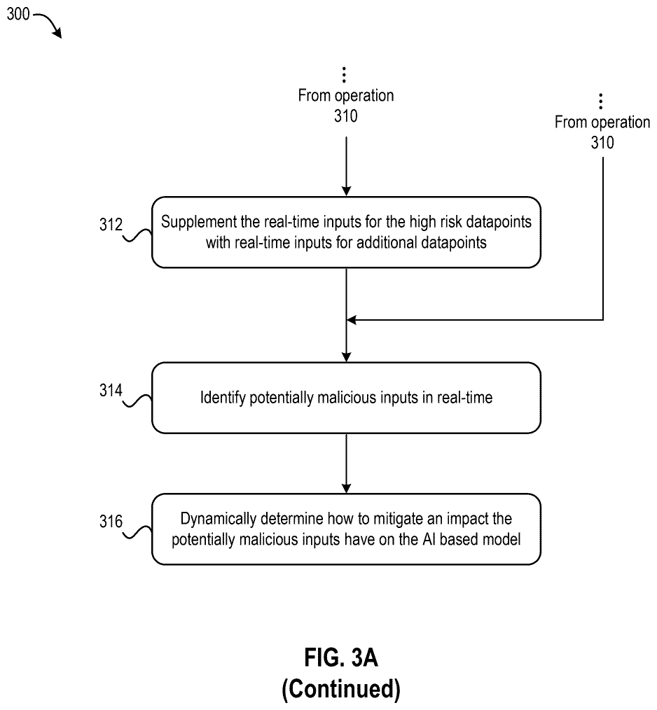

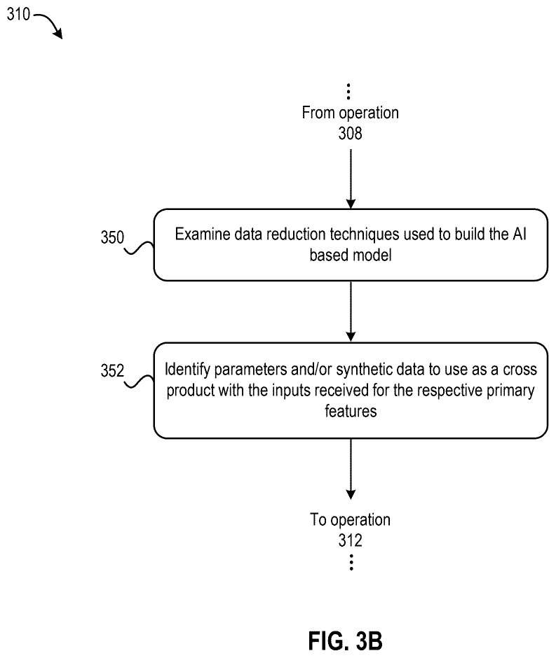

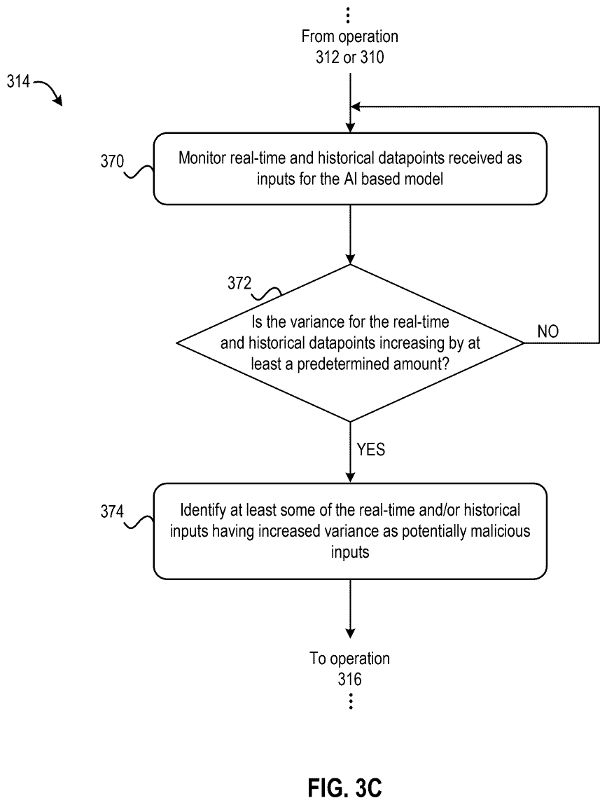

Looking now to FIG. 3A, a flowchart of a computer-implemented-method 300 for monitoring the datapoints provided as inputs to one or more AI based models. Operations in method 300 may thereby include identifying attack vectors intrinsic to AI models using different processes, monitor inputs intended for the AI models in real-time, and dynamically determine how to mitigate the impact potentially malicious input(s) have on the AI based models. For instance, method 300 trains one or more AI models to determine the influence strengths different features in a model being evaluated have on the output(s) produced by the model. Method 300 may thereby be able to evaluate other trained models, and determine the way the features in those models being evaluate weigh on the nodes therein.

The method 300 may be performed in accordance with the present invention in any of the environments depicted in FIGS. 1-2, among others, in various embodiments. Of course, more or less operations than those specifically described in FIG. 3A may be included in method 300, as would be understood by one of skill in the art upon reading the present descriptions.

Each of the steps of the method 300 may be performed by any suitable component of the operating environment. For example, in some approaches one or more of the operations in method 300 may be performed by a source hardened AI based model which is implemented in an AI based module (e.g., see AI modules 213, 238 of FIG. 2). However, the method 300 may be partially or entirely performed by a controller, a processor, a computer, etc., or some other device having one or more processors therein. Moreover, the terms computer, processor and controller may be used interchangeably with regards to any of the embodiments herein, such components being considered equivalents in the many various permutations of the present invention.

For those embodiments having a processor, the processor, e.g., processing circuit(s), chip(s), and/or module(s) implemented in hardware and/or software, and preferably having at least one hardware component may be utilized in any device to perform one or more steps of the method 300. Illustrative processors include, but are not limited to, a central processing unit (CPU), an application specific integrated circuit (ASIC), a field programmable gate array (FPGA), etc., combinations thereof, or any other suitable computing device known in the art.

As shown, operation 302 includes evaluating an AI based model. In some approaches, operation 302 is performed in response to receiving a request (e.g., from a user) to evaluate the AI based model. In other approaches, operation 302 is performed in response to an AI based model being added to a module, undergoing re-training, being queried to process one or more data streams, etc. It follows that operation 302 may include sending one or more instructions that result in the AI based model being evaluated as desired.

From operation 302, method 300 advances to operation 304. There, operation 304 includes determining influence strengths of features in the AI based model evaluated. In other words, operation 304 identifies features in the AI based model, and determines how strongly each of these features affect other features and the output produced by the model. Operation 304 evaluates how the identified features weigh on the nodes in the AI based model itself. For example, determining that an AI model is overly reliant on a particular feature may result in determining the feature has an undesirably strong influence on the AI model.

The features and the respective amount by which they influence the underlying AI based model may be represented in any desired way using any desired medium. For instance, some approaches may include converting the features and their respective influence strengths into a graphical representation, a text based description of the features and respective influence strengths, groupings of the features having similar influence strengths, etc. Operation 304 thereby develops a thorough understanding of the features and their respective impact strengths.

Method 300 proceeds from operation 304 to operation 306. There, operation 306 includes identifying high risk datapoints used as inputs by the AI based model. In other words, operation 306 includes identifying inputs for the AI based model that are received externally, e.g., from sensors, one or more other trained models, users, running applications, etc. The process of identifying the high risk datapoints preferably includes evaluating the influence strengths of the features determined in operation 304. In other words, high risk datapoints may be identified as corresponding to (e.g., serving as inputs for) “primary features” in the AI model that have high impact strengths, e.g., that have a relatively larger impact than other features, that are predefined as primary features, that have an impact value (quantified via known techniques) above a predefined threshold, etc. These primary features may thereby be evaluated by a trained model to determine modifications that reduce and/or eliminate the bias that high risk datapoints can provide to the AI based model as a whole.

In other approaches, high risk datapoints may be identified by evaluating the features and identifying ones that rely on an undesirably low number of inputs. For example, a feature that receives fewer inputs than a predetermined threshold may be flagged, and the corresponding inputs may be identified as high risk datapoints for the AI based model as a whole. It follows that approaches herein are able to evaluate the importance of different features, identify high risk datapoints, and gather the real-time high risk datapoints (e.g., inputs) for these features. Some approaches may implement correlation matrices, variation factors, principal component analysis (PCA) with variance explanation, etc., or any other processes which would be apparent to one skilled in the art after reading the present description.

Again, these high risk datapoints are susceptible to malicious manipulation intended to materially impact outputs of the AI model. Thus, by identifying these high risk datapoints and monitoring the corresponding features in the AI model, approaches herein are desirably able to identify potentially malicious inputs in real-time. Approaches are also able to generate modifications to the AI model and/or the input datapoints which are configured to reduce an impact the potentially malicious inputs have on the AI based model. In other words, the modifications to the AI based model cause changes to the influence strengths of features, e.g., as will be described in further detail below.

Proceeding from operation 306, method 300 advances to operation 308. There, operation 308 includes gathering (e.g., receiving) and evaluating real-time inputs for the identified high risk datapoints of the respective primary features. In other words, operation 308 includes monitoring information as it is received in real-time for the high risk datapoints. This allows for approaches herein to monitor external information as it is received and (selectively) supplied to an AI based model. Again, particular emphasis may be placed on monitoring the high risk datapoints and respective features, but additional information may be beneficial in certain implementations.

For example, AI based models that receive or use sensitive information (e.g., financial transactions, medical records, personal data, etc.) as inputs may be evaluated in further detail to ensure with greater certainty that malicious inputs are not received and processed. Accordingly, operation 310 includes determining whether additional datapoints are desired. In other words, operation 310 determines whether any other incoming datapoints should be monitored to determine if any fake or modified datapoints are being received as inputs, rather than genuine (e.g., authentic) datapoints received from the intended source(s) (e.g., sensors). In some approaches, a summary of the inputs received for the high risk datapoints may be generated and used to determine whether supplemental information is desired. This summary may be evaluated by a supplemental AI model that has been trained to inspect the received inputs for values that have high variance, that stop being received, that start being received, etc., in order to determine whether supplemental information is desired. In other approaches, a summary may be generated and sent to an administrator, a user, one or more other running programs, etc., and a response may be received indicating whether supplemental information is desired.

Referring momentarily to FIG. 3B, exemplary sub-operations of determining whether additional datapoints are desired are illustrated in accordance with one approach. It follows that one or more of these sub-operations may be used to perform operation 310 of FIG. 3A. However, it should be noted that the sub-operations of FIG. 3B are illustrated in accordance with one approach which is in no way intended to be limiting.

Sub-operation 350 includes examining data reduction techniques used to build the AI based model. In other words, sub-operation 350 includes examining the AI based model (having the primary features) and identifying data reduction techniques that were implemented while constructing (e.g., building) the AI based model. This desirably provides insight into parameters that could be used as a cross product (e.g., synthetic data) to validate the inputs received as high risk datapoints for the primary features. Moreover, sub-operation 352 includes identifying parameters and/or synthetic data to use as a cross product with the inputs received for the respective primary features. Thus, by evaluating how an AI based model is constructed, approaches herein are able to evaluate inputs received for different features (e.g., primary features) in different combinations and/or with different emphasis.

Returning now to FIG. 3A, method 300 proceeds to operation 312 from operation 310 in response to determining that supplemental information is desired. There, operation 312 includes supplementing the real-time inputs for the high risk datapoints with real-time inputs for additional datapoints. Operation 312 thereby includes gathering (e.g., receiving) and evaluating real-time inputs for the high risk datapoints and the additional datapoints of the respective features. The additional datapoints may serve as supplemental information that can validate the inputs received for the high risk datapoints. In some approaches, the additional (e.g., supplemental) datapoints are used as a cross product with the inputs received for the high risk datapoints.

From operation 312, method 300 advances to operation 314. Method 300 also advances directly to operation 314 from operation 310 in response to determining that supplemental information is not desired. There, operation 314 includes identifying potentially malicious input(s) in real-time. The potentially malicious inputs are identified based at least in part on the evaluation of the real-time inputs in operation 308 and/or 312. In some approaches, the potentially malicious inputs are identified based at least in part on the influence strengths determined in operation 304.

Referring momentarily now to FIG. 3C, exemplary sub-operations of identifying potentially malicious input(s) in real-time are illustrated in accordance with one approach. It follows that one or more of these sub-operations may be used to perform operation 314 of FIG. 3A. However, it should be noted that the sub-operations of FIG. 3C are illustrated in accordance with one approach which is in no way intended to be limiting.

As shown, sub-operation 370 includes monitoring real-time and historical datapoints received as inputs for the AI based model. In some approaches, sub-operation 370 includes identifying and monitoring real-time and historical sensor output activity The historical sensor output activity may thereby serve as a baseline that can quantify the real-time activity. In some approaches, sub-operation 370 includes monitoring collinearity of the datapoints received as inputs. Sub-operation 370 may also include monitoring any trends of the cross product of the datapoints (e.g., sensor output activity) over time. In other approaches, sub-operation 370 may include identifying and monitoring any additional metrics (e.g., different than a standard set of metrics) that correspond to collinearity.

The flowchart advances from sub-operation 370 to sub-operation 372. There, sub-operation 372 includes determining whether the variance for the real-time and historical datapoints received as inputs for the AI based model is increasing by at least a predetermined amount. In other words, sub-operation 372 includes determining whether a difference between the historical datapoints (e.g., and/or other learned understandings of the AI model and how it operates) and the real-time inputs has increased past a predetermined range. As noted above, inputs for high risk datapoints and the corresponding primary features are targets for malicious inputs intending to impact (e.g., control) an output of an AI model. However, by identifying uncharacteristic changes in the inputs (e.g., sensor outputs) received for these high risk datapoints and/or supplemental datapoints, approaches herein are able to identify potentially malicious inputs, insulating the AI model from undesired external inputs. It should be noted that “past a predetermined range” is in no way intended to be limiting. Rather than determining whether a value is past a predetermined range, equivalent determinations may be made, e.g., as to whether a value is above a threshold, whether a value is outside a predetermined range, whether an absolute value is above a threshold, whether a value is below a threshold, etc., depending on the desired approach.

With continued reference to FIG. 3C, the flowchart returns to sub-operation 370 from sub-operation 372 in response to determining that the variance for the real-time and historical datapoints received as inputs for the AI based model has not increasing by at least a predetermined amount. In other words, the flowchart returns to sub-operation 370 such that additional real-time and/or historical data may be evaluated in an effort to identify (e.g., catch) any malicious inputs that are received.

In some approaches, the range of inputs that are monitored in sub-operations 370, 372 and/or criteria of the real-time and historical sensor output activity are continuously updated with each iteration of repeating the sub-operations. The range of inputs and/or criteria may thereby be adjusted over time to shift focus on different aspects (features) of the AI model.

Alternatively, the flowchart advances from sub-operation 372 to sub-operation 374 in response to determining that the variance for the real-time and historical datapoints received as inputs for the AI based model is increasing by at least a predetermined amount. There, sub-operation 374 includes identifying at least some of the real-time and/or historical inputs having increased variance as potentially malicious inputs. In other words, in response to determining that the variance is increasing by at least the predetermined amount, a corresponding portion of the real-time and/or historical sensor output activity is identified as being potentially malicious input(s). The inputs identified as being potentially malicious may be discarded from evaluation, at least temporarily stored in a secured location (e.g., on a virtual machine), returned to a user for evaluation, evaluated by one or more additional AI models, etc.

According to one example, which is in no way intended to be limiting, sub-operation 374 may involve generating remediation activities that are configured to return the sensor output activity to inside a predetermined range. For instance, sub-operation 374 may be performed in response to determining sensor output activity has moved outside a predetermined (e.g., expected) range for one or more external sensors. In other words, in response to determining at least one leading indicator in sensor output activity has moved outside a respective expected range, sub-operation 374 may be performed in order to provide data, features, edge device(s) applicable, etc., that are used to generate the remediation activities.

In some approaches, sub-operation 374 includes causing one or more sensors which supplied (or otherwise correspond to) the sensor output activity identified as being outside the predetermined range to be inspected. Based at least in part on this inspection, remediation activities configured to return the sensor output activity inside the predetermined range are generated. In some approaches, these remediation activities are generated based on monitoring the relationships between the sensors that supplied (or otherwise correspond to) the sensor output activity identified as being outside the predetermined range, and other sensors that may be in a same system. As noted above, monitoring the relationships between different inputs may provide additional insight into whether local variance is experienced across different inputs. For example, local variance experienced with inputs for a high risk datapoint that is not experienced in the inputs for other “removed” datapoints may be identified as malicious activity with more certainty. For instance, this is in comparison to a situation where local variance matches wide-spread variance, which may correspond to a genuine (non-malicious) phenomenon that impacts all inputs to an AI based model, e.g., as a new dataset.

Returning now to FIG. 3A, method 300 advances from operation 314 to operation 316. There, operation 316 includes dynamically determining how to mitigate an impact the potentially malicious inputs have on the AI based model. In other words, operation 316 includes causing the potentially malicious inputs identified in operation 314 to be excluded from any current (e.g., ongoing) implementations of the AI based model. In some approaches, operation 316 includes modifying the AI model itself such that subsequent inputs are not able to have such a substantial impact on output(s) that are generated by the AI model. For instance, one or more features in the AI model may be modified such that the influence strength of the features and the inputs thereof are adjusted to prevent potentially malicious inputs. For example, the importance of a particular feature may be reduced. Performing operation 316 thereby insulates the AI model from external control by modifying the impact that specific inputs have on the output generated by the AI model.

In some approaches, operation 316 includes repairing the source(s) of the inputs such that the datapoints received are verified. In other words, operation 316 may involve performing predictive sensor analysis steps. Thus, in addition to ensuring features of the AI model are properly configured, approaches herein take further steps to ensure outputs generated by AI based models have not been tampered with. For example, operation 316 may include securing any edge sensors that provide data used as inputs in the AI based model. In other approaches, one or more Proxy Auto-Configuration (PAC) files may be used to identify and mitigate any malicious inputs. In still other approaches, one or more new features may be synthesized and implemented in the AI based model in order to mitigate any malicious inputs.

Repairs to the input sources and/or modifications to the features of an AI model may be achieved by sending one or more instructions (e.g., commands, requests, programs, etc.) to a target location. For example, a processor may send one or more instructions to an AI module that cause one or more models therein to be modified as desired (e.g., see processor 212 and AI module 213 of FIG. 2).

In some approaches, method 300 may return to operation 302 from operation 316, e.g., such that the AI based model(s) may continue to be monitored. It follows that the operations of method 300 may be repeated any desired number of times in order to ensure (e.g., validate) the results generated by the AI based model(s). In some approaches, an optional operation (not shown) may be performed in which additional metrics are used to monitor collinearity. Accordingly, operation 316 may include identifying and monitoring any additional metrics (e.g., different than a standard set of metrics) that correspond to collinearity. In other approaches, method 300 may end in response to performing operation 316. The resulting AI based model and the inherent dependencies corresponding to the features included therein may thereby be output, e.g., for use.

In some approaches, the operations of method 300 may be performed by an AI model that is trained using a predetermined training set of data. For example, in some approaches, various of the operations noted above may be deployed in a trained state of a trained AI model. Training of the AI model, in some approaches, may be performed by applying a predetermined training data set to learn how to identify attack vectors intrinsic to AI models using different processes, monitor inputs intended for the AI models in real-time, and/or dynamically determine how to mitigate the impact potentially malicious input(s) have on the AI based models. Initial training may include reward feedback that may, in some approaches, be implemented using a subject matter expert (SME) that generally understands how influence strengths of inputs and corresponding factors impact the outputs generated by AI based models. However, to prevent costs associated with relying on manual actions of a SME, in another approach, reward feedback may be implemented using techniques for training a BERT model, as would become apparent to one skilled in the art after reading the present disclosure. Once a determination is made that the AI model achieves a redeemed threshold of accuracy of performing the operations described herein during this training, a decision that the model is trained and ready to deploy for performing techniques and/or operations of method 300 may be performed. In some further approaches, the AI model may be a neuromyotonic AI model that may improve performance of computer devices in an infrastructure associated with generating (e.g., building), training, and/or implementing models, because the neuromyotonic AI model may not need an SME and/or iteratively applied training with reward feedback in order to accurately perform operations described herein. Instead, the neuromyotonic AI model is configured to itself make determinations described in operations herein.

Weight values may, in some approaches, be used by the AI reasoning model to collect and analyze information and/or feedback potentially received in response to generated answers being provided by another model. Such an AI model ensures that re-training occurs, during which the accuracy of the outputs generated by the AI model(s) is evaluated. In situations where the accuracy of the generated outputs decline, the datapoints provided as inputs to the model and/or the configuration of the model itself (e.g., features in the model) may be shifted (e.g., weighted) such that the AI model(s) produce more accurate outputs in response to received inputs as a result of the re-training, where the scale of such analysis and determinations would not otherwise be feasible for a human to perform. This is because humans are not able to efficiently perform complex re-training resulting from dynamic evaluation of generated outputs to complex combinations of details input into the model, and would otherwise incorporate processing delays and errors in the process of attempting to do so. Accordingly, management of operations described herein is not able to be achieved by human manual actions.

According to a simplified example, a model used for making decisions regarding airport flight scheduling may rely on readings received from an edge wind and/or temperature sensor. In some situations, this data may even be provided as weather data from a third party. A malicious attack may thereby compromise the sensors and/or data feed coming from the sensors, and drive the model relying on the sensor data as inputs to impact flight scheduling. However, approaches herein are desirably able to observe collinearity between various data sources and/or model features, e.g., such as temperature, wind, etc. in Camden airport and Sydney airport. Rather than drop one of these dimensions in order to simplify the model, approaches are able to implement these additional inputs (that have relationships with multiple other features, dimensions, variables, etc.) in the resulting model. The model(s) may thereby be trained to detect malicious injection of fake sensor data, external data supplies, etc. According to the example, if a Sydney airport temperature sensor was compromised (or the data feed therefrom), it could be automatically cross-checked by the influence of other sensors in the environment. Moreover, by evaluating the influence strengths that features in the model using the compromised temperature sensor data have, approaches herein are able to generate and recommend modifications to the configuration of the model itself and features therein. In another simplified example, energy markets use temperature at locations as a measure of the impact that solar rooftops have on the overall grid performance. Thus, by placing an external heat source (e.g., hairdryer) near one of the few temperature sensors that are used to model the solar rooftop, a malicious entity can impact the responsiveness and output of a model trained to evaluate and model the energy operators.

As noted above, data poisoning style attacks impact AI based models, but conventional products have been unable to prevent models from being susceptible to these attacks. While model bias, drift, fairness, and other metrics are considered while evaluating performance of a model, conventional products are simply unable to analyze the posture of a model against injection style attacks.

In sharp contrast, approaches herein evaluate whether models have an over-reliance on features in datasets. Again, this insight allows for the models themselves to be modified such that the impact that extraneous inputs and/or data points has is removed or reduced. The benefits provided by approaches herein will only continue to be more advantageous as AI based attacks continue to increase in frequency and sophistication. Approaches herein may thereby be implemented in one or more software suites to detect and mitigate malicious attacks.

Approaches herein evaluate and address the risk associated with building models that rely on an undesirably low number of inputs to produce a result. These approaches not only identify these risks by evaluating the inner workings of an AI based model(s), but also determine how to modify the AI based model(s) to mitigate those risks, and further still how to put metrics in place to detect those risks being exploited moving forward.

Accordingly, while various approaches herein are described in the context of identifying data poisoning style attacks and taking steps to insulate (e.g., protect) one or more AI based models against such attacks, the approaches herein are targeted at understanding how real-time data readings may impact the AI based models. As described above, by analyzing the trust and reliance a given AI based model (e.g., machine learning model) has on a specific edge sensor, as well as the edge sensor's susceptibility to being compromised, gives approaches herein insight into how the AI based models may be manipulated, along with modifications that can be made to the AI based models to insulate them from being manipulated as such. For instance, other sensors in the same area or region may also be considered, and these data points may be used as safeguards against injection style attacks. These considerations and/or modifications to the AI based models may further be output as suggestions, automatically implemented in the models themselves, etc., depending on the approach. Some approaches add data points back into an analysis that may have been previously ignored, e.g., for not being the primary driver of the model outcome. Thus, by bring those data points back into consideration, not just for their predictive power, but also for their use as a secondary control to validate that the primary data feed is not being distorted allows for the approaches herein to achieve significant improvements in model performance by insulating the models from malicious control.

As noted above, these improvements are accomplished in a few different ways. For instance, some approaches perform risk analysis of models to determine their dependence on external inputs (e.g., readings from sensors). The higher the dependence on external inputs, the higher the risk to the model and a lower trustworthiness of outputs produced by the model. For inputs and/or model features that have a higher dependence on one or more inputs, suggestions may be made that additional inputs or cross products are incorporated in order to validate the original inputs and/or expand the AI based model to not be as dependent on the original inputs. For example, a dimensionless additional features (PCA output) could be used to monitor multiple input features.

Other approaches perform predictive sensor analysis. For instance, approaches monitor real-time and/or historical sensor activity, and measure when activity (e.g., outputs) of the monitored sensor moves out of an expected range. Moving out of this expected range may thereby trigger an inspection of the predictive sensor and/or against the proxy PCA synthetic sensor.

Still other approaches involve modifying governance. For example, some approaches involve ongoing assessment and measurement to determine when a sensor providing inputs to one or more AI based models is likely compromised. Some approaches further include modifying one or more AI based models determined as having dependencies on respective sensors that breaches a predetermined threshold.

It will be clear that the various features of the foregoing systems and/or methodologies may be combined in any way, creating a plurality of combinations from the descriptions presented above.

It will be further appreciated that implementations of the present invention may be provided in the form of a service deployed on behalf of a customer to offer service on demand.

The descriptions of the various implementations of the present invention have been presented for purposes of illustration, but are not intended to be exhaustive or limited to the implementations disclosed. Many modifications and variations will be apparent to those of ordinary skill in the art without departing from the scope and spirit of the described implementations. The terminology used herein was chosen to best explain the principles of the implementations, the practical application or technical improvement over technologies found in the marketplace, or to enable others of ordinary skill in the art to understand the implementations disclosed herein.

What is claimed is:

1. A method comprising:
determining influence strengths of features corresponding to an artificial intelligence (AI) based model;
based at least in part on the influence strengths of the features, identifying high risk datapoints;
evaluating real-time inputs for the high risk datapoints of the respective features;
based at least in part on the evaluation of the real-time inputs and/or the determined influence strengths, identifying potentially malicious input(s); and
dynamically determining how to mitigate an impact the potentially malicious input(s) have on the AI based model.

2. The method of claim 1, wherein the dynamically determining how to mitigate the potential malicious inputs includes:
generating modifications to the AI based model that cause changes to the influence strengths of features.

3. The method of claim 1, further comprising:
determining whether additional datapoints are desired, by:
examining data reduction techniques used to build the AI based model, and
identifying parameters and/or synthetic data to use as a cross product with the respective features.

4. The method of claim 3, further comprising:
in response to determining additional datapoints are desired, supplementing the real-time inputs for the high risk datapoints with real-time inputs for additional datapoints.

5. The method of claim 1, wherein the identifying potentially malicious input(s) includes:
monitoring real-time and historical sensor output activity; and
in response to determining the sensor output activity has moved outside a predetermined range:
causing one or more sensors which supplied the sensor output activity outside the predetermined range to be inspected, and
generate remediation activities configured to return the sensor output activity inside the predetermined range.

6. The method of claim 5, further comprising:
monitoring relationships between: the one or more sensors which supplied the sensor output activity outside the predetermined range, and other sensors; and
continuously updating range and criteria of the real-time and historical sensor output activity that is monitored.

7. The method of claim 5, wherein the monitoring real-time and historical sensor output activity comprises:
monitoring collinearity and a cross product of the sensor output activity; and
determining if variance is increasing by a predetermined amount.

8. The method of claim 7, further comprising:
in response to determining that the variance is increasing by at least the predetermined amount,
identifying a corresponding portion of the real-time and/or historical sensor output activity as potentially malicious input(s).

9. A computer program product comprising:
one or more computer-readable storage media; and
program instructions stored on the one or more storage media to perform operations comprising:
determining influence strengths of features corresponding to an artificial intelligence (AI) based model;
based at least in part on the influence strengths of the features, identifying high risk datapoints;
evaluating real-time inputs for the high risk datapoints of the respective features;
based at least in part on the evaluation of the real-time inputs and/or the determined influence strengths, identifying potentially malicious input(s); and
dynamically determining how to mitigate an impact the potentially malicious input(s) have on the AI based model.

10. The computer program product of claim 9, wherein the dynamically determining how to mitigate the potential malicious inputs includes:
generating modifications to the AI based model that cause changes to the influence strengths of features.

11. The computer program product of claim 9, wherein the operations further comprise:
determining whether additional datapoints are desired, by:
examining data reduction techniques used to build the AI based model, and
identifying parameters and/or synthetic data to use as a cross product with the respective features.

12. The computer program product of claim 11, wherein the operations further comprise:
in response to determining additional datapoints are desired, supplementing the real-time inputs for the high risk datapoints with real-time inputs for additional datapoints.

13. The computer program product of claim 9, wherein the identifying potentially malicious input(s) includes:
monitoring real-time and historical sensor output activity; and
in response to determining the sensor output activity has moved outside a predetermined range:
causing one or more sensors which supplied the sensor output activity outside the predetermined range to be inspected, and
generate remediation activities configured to return the sensor output activity inside the predetermined range.

14. The computer program product of claim 13, wherein the operations further comprise:
monitoring relationships between: the one or more sensors which supplied the sensor output activity outside the predetermined range, and other sensors; and
continuously updating range and criteria of the real-time and historical sensor output activity that is monitored.

15. The computer program product of claim 13, wherein the monitoring real-time and historical sensor output activity comprises:
monitoring collinearity and a cross product of the sensor output activity; and
determining if variance is increasing by a predetermined amount.

16. The computer program product of claim 15, wherein the operations further comprise:
in response to determining that the variance is increasing by at least the predetermined amount,
identifying a corresponding portion of the real-time and/or historical sensor output activity as potentially malicious input(s).

17. A computer system comprising:
a processor set;
one or more computer-readable storage media; and
program instructions stored on the one or more storage media to cause the processor set to perform operations comprising:
determining influence strengths of features corresponding to an artificial intelligence (AI) based model;
based at least in part on the influence strengths of the features, identifying high risk datapoints;
evaluating real-time inputs for the high risk datapoints of the respective features;
based at least in part on the evaluation of the real-time inputs and/or the determined influence strengths, identifying potentially malicious input(s); and
dynamically determining how to mitigate an impact the potentially malicious input(s) have on the AI based model.

18. The computer system of claim 17, wherein the identifying potentially malicious input(s) includes:
monitoring real-time and historical sensor output activity; and
in response to determining the sensor output activity has moved outside a predetermined range:
causing one or more sensors which supplied the sensor output activity outside the predetermined range to be inspected, and
generate remediation activities configured to return the sensor output activity inside the predetermined range.

19. The computer system of claim 18, wherein the operations further comprise:
monitoring relationships between: the one or more sensors which supplied the sensor output activity outside the predetermined range, and other sensors; and
continuously updating range and criteria of the real-time and historical sensor output activity that is monitored.

20. The computer system of claim 18, wherein the monitoring real-time and historical sensor output activity comprises:
monitoring collinearity and a cross product of the sensor output activity;
determining if variance is increasing by a predetermined amount; and
in response to determining that the variance is increasing by at least the predetermined amount, identifying a corresponding portion of the real-time and/or historical sensor output activity as potentially malicious input(s).
